(19) United States
(12) Patent Application Publication
(10) Pub. No.: US 2011/0142029 A1
(43) Pub. Date: Jun. 16, 2011

(54) NETWORKING IN WIRELESS COMMUNICATION SYSTEMS

(75) Inventors: Mika KASSLIN, Espoo (FI); Mikko TIRRONEN, Helsinki (FI); Kari LEPPÄNEN, Helsinki (FI); Sami VIRTANEN, Espoo (FI); Enrico RANTALA, Iittala (FI); Markku TURUNEN, Helsinki (FI)

(73) Assignee: Nokia Corporation, Espoo (FI)

(21) Appl. No.: 12/635,187

(22) Filed: Dec. 10, 2009

(51) Int. Cl. H04J 3/06

(52) U.S. Cl. 370/350

(57) ABSTRACT

A system where apparatuses may stay synchronized with a network utilizing a reduced beacon period based on an integer multiple of a standard beacon period that is established for the network. The reduced beacon periods may initiate scanning opportunities, which are periods of time during which apparatuses may passively scan for beacon messages broadcast from other apparatuses, which upon receipt in a scanning apparatus may trigger the transmission of network information messages. Network information messages may comprise connectivity information that would be usable by outside apparatuses to determine whether participation in the network described in the network information message (e.g., another network) is desired. If the apparatus desires to interact with apparatuses in the other network, then further decisions may be made with respect to how communication between these entities should be established.

### BACKGROUND

1. Field of Invention

Embodiments of the present invention pertain to wireless communication, and in particular, to communicating network characteristic information to non-network apparatuses.

2. Background

Wireless communication has evolved from being a means for verbal information to being more focused on total digital interactivity. Enhancements in wireless technology have substantially improved communication abilities, quality of service (QoS), speed, etc., which has contributed to an insatiable desire for new device functionality. As a result, portable wireless apparatuses are no longer just tasked with making telephone calls. They have become integral, and in some cases essential, tools for managing the professional and/or personal life of users.

In order to support the desired expansion of electronic communication, more and more applications that did not incorporate any communication functionality are being redesigned to support wired and/or wireless communication. Such wireless communication support may, in some instances, include the ability to send monitored or observed data to other apparatuses via wireless communication. Example usage scenarios may include natural resource monitoring, biometric sensors, systems for supporting financial transactions, personal communication and/or location devices, etc. Apparatuses such activities and subsequent communications often operate using limited resources. For example, these apparatuses may be simple (e.g., may have limited processing resources), may be small (e.g., may have space constraints due to size limitations imposed in retrofit applications), may have power constraints (e.g., battery powered), etc.

Link establishment and maintenance processes defined in existing communication protocols may not be appropriate for apparatuses operating with resource constraints such as set forth above. For example, standards for existing wireless communication protocols may require periodic interaction in order to keep apparatuses participating in the network synchronized with other apparatuses. These requirements may not take into consideration the burden that periodic network communication places upon resource-constrained devices. As a result, it may become difficult to operate such resource-constrained apparatuses in accordance with these standards.

### SUMMARY

Example embodiments of the present invention may be directed to a method, apparatus, computer program and system for facilitating apparatus interaction while conserving apparatus resources. In accordance with at least one example implementation, apparatuses may stay synchronized with a network utilizing a reduced or diluted beacon interval that is an integer multiple of a network beacon period signal being transmitted at a set interval. Diluted beacon intervals may reduce communication burden for apparatuses since the need to communicate is less frequent. Scanning opportunities, which are instances where apparatuses may perform either passive scanning or network communication activities like beaconing, may also have start times and/or durations that are based upon an integer multiple of the network beacon signal interval.

During scanning opportunities apparatuses may opt to passively scan for beacon signals broadcast from other apparatuses, the receipt of which may trigger the transmission of network information messages from the scanning apparatuses. Network information messages may comprise connectivity information usable by apparatuses that wish to join the network. In accordance with at least one embodiment of the present invention, apparatuses outside of the network that receive network information messages may determine whether participation in the network described in the received network information message (e.g., other network) is desired. If the apparatus desires to interact with apparatuses in the other network, then further decisions may be made with respect to how communication between these entities should be established.

For example, apparatuses that receive network information messages may already be active in one or more networks. A decision to also participate in additional networks, or to move all operations from the one or more networks to a new network, may force some or all of the networks to be reconfigured. For example, apparatuses that enter into new networks while still participating in existing networks may force synchronization (e.g., timing changes) to occur in the networks. Problems may result when larger networks are forced to synchronize to smaller networks, which may worsen the impact of disruptions that may be caused by synchronization.

In accordance with at least one embodiment of the present invention, network information messages may comprise network size information. Network size information may be encoded in a fixed position in a message frame (e.g., such as in a basic service set identifier) and may inform receiving apparatuses of an approximate size for the network corresponding to the network information message. Network sizes may then be compared by apparatuses when determining whether to maintain clock timing or to synchronize to the timing of a new network.

The above summarized configurations or operations of various embodiments of the present invention have been provided merely for the sake of explanation, and therefore, are not intended to be limiting. Moreover, inventive elements associated herein with a particular example embodiment of the present invention can be used interchangeably with other example embodiments depending, for example, on the manner in which an embodiment is implemented.

### DESCRIPTION OF DRAWINGS

The disclosure will be further understood from the following description of various exemplary embodiments, taken in conjunction with appended drawings, in which:

FIG. 1 discloses examples of hardware and software resources that may be utilized when implementing various example embodiments of the present invention.

FIG. 2 discloses an example network environment in accordance with at least one example embodiment of the present invention.

FIG. 3 discloses examples of various types of messaging that may be utilized in accordance with at least one example embodiment of the present invention.

FIG. 4 discloses an example of inter-apparatus message propagation, which may result in distributed local web formation, in accordance with at least one example embodiment of the present invention.

FIG. 5 discloses example beacon implementations that are usable in accordance with at least one example embodiment of the present invention.

FIG. 6 discloses an example of awake windows in accordance with at least one example embodiment of the present invention.

FIG. 7 discloses examples of access control strategies in accordance with at least one example embodiment of the present invention.

FIG. 8 discloses example scanning opportunity initialization and duration in accordance with at least one example embodiment of the present invention.

FIG. 9 discloses examples of scanning opportunity utilization, and a possible lack of utilization, in accordance with at least one example embodiment of the present invention.

FIG. 10 discloses a more detailed example of scanning opportunity utilization in accordance with at least one example embodiment of the present invention.

FIG. 11 discloses an example scenario including two networks usable for the sake of explanation in accordance with at least one embodiment of the present invention.

FIG. 12 discloses an example network information message, with corresponding detail, in accordance with at least one embodiment of the present invention.

FIG. 13 discloses at least one possible effect that the various embodiments of the present invention might have on the example previously disclosed in FIG. 11.

FIG. 14 discloses a flowchart for an example communication control process in accordance with at least one example embodiment of the present invention.

### DESCRIPTION OF EXEMPLARY EMBODIMENTS

While the present invention has been described herein in terms of a multitude of example embodiments, various changes or alterations can be made therein without departing from the spirit and scope of the present invention, as set forth in the appended claims.

I. General System with which Embodiments of the Present Invention May be Implemented

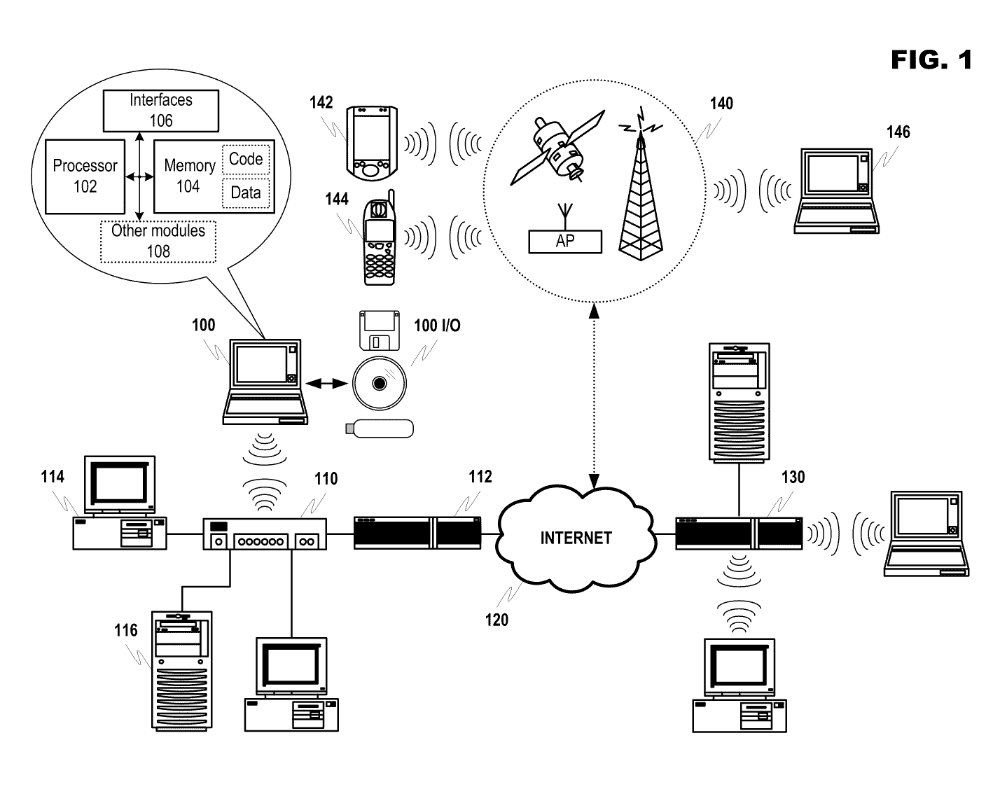

An example system usable as a basis for explaining the various embodiments of the present invention is disclosed in FIG. 1. The apparatuses and configurations shown in FIG. 1 are merely representative, and thus, may be included in, or omitted from, actual implementations.

Computing device 100 may correspond to various processing-enabled apparatuses including, but not limited to, micro personal computers (UMPC), netbooks, laptop computers, desktop computers, engineering workstations, personal digital assistants (PDA), computerized watches, wired or wireless terminals/nodes/etc., mobile handsets, set-top boxes, personal video recorders (PVR), automatic teller machines (ATM), game consoles, or the like. Elements that represent basic example components comprising functional elements in computing device 100 are disclosed at 102-108. Processor 102 may comprise one or more components configured to execute instructions, for instance, wherein a group of instructions may constitute program code. In at least one scenario, the execution of program code may include receiving input information from other elements in computing device 100 in order to formulate an output (e.g., data, event, activity, etc). Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired and/or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Examples of removable storage media based on magnetic, electronic and/or optical technologies are shown at 100 I/O in FIG. 1, and may serve, for instance, as a data input/output means. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks also shown in FIG. 1. For example, communication hub 110 may provide wired and/or wireless support to devices such as computer 114 and server 116. Communication hub 110 may also be coupled to router 112, allowing devices in the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may interact with computing device 100 over Internet 120 as facilitated by wireless communication 140. Similar functionality may be also be included in other apparatuses, such as laptop computer 146, in the form of hardware and/or software resources configured to allow short and/or long range wireless communication.

### II. Example Networking Environment

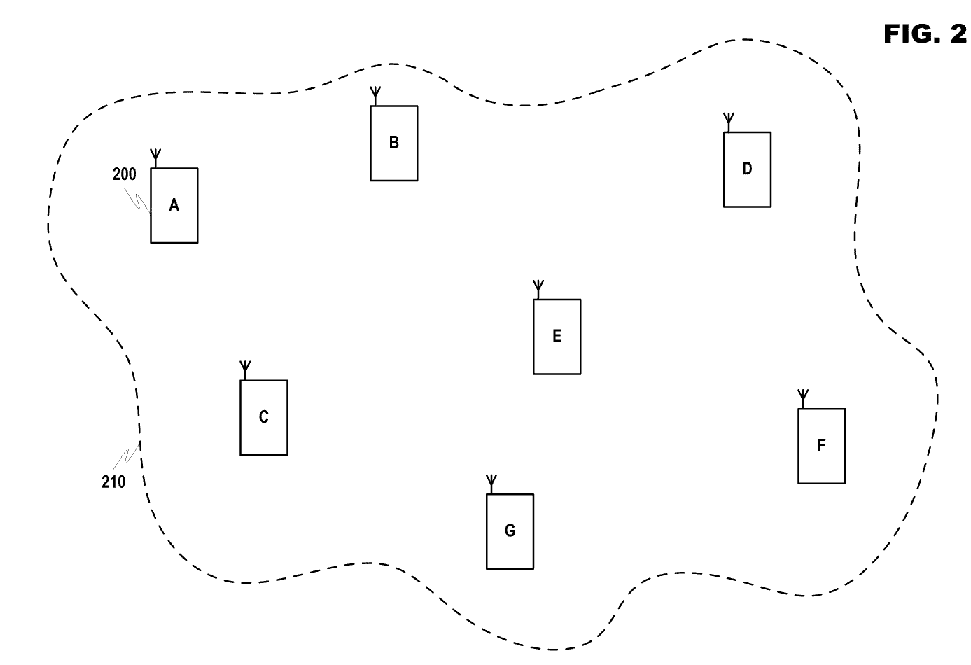

FIG. 2 discloses an example of an operational space that will be used to explain the various example embodiments of the present invention. As this example scenario is utilized herein only for the sake of explanation, implementations of the present invention are not limited specifically to the disclosed example. Operational spaces may be defined using different criteria. For example, physical areas like buildings, theatres, sports arenas, etc. may define a space where users may interact. Alternatively, operational spaces may be defined in terms of apparatuses that utilize particular wireless transports, apparatuses that are within communication range (e.g., a certain distance) of each other, apparatuses that are members of certain classes or groups, etc.

Wireless-enabled apparatuses 200 are labeled “A” to “G” in FIG. 2. Apparatuses 200 may, for example, correspond to any of the wireless-enabled apparatuses that were disclosed in FIG. 1, and may further include at least the resources discussed with respect to apparatus 100. These apparatuses may further operate utilizing at least one common wireless communication protocol. That is, all of the apparatuses disclosed in FIG. 2 may interact with each other within the operational space, and thus, may participate together in a wireless communication network.

### III. Examples of Messaging

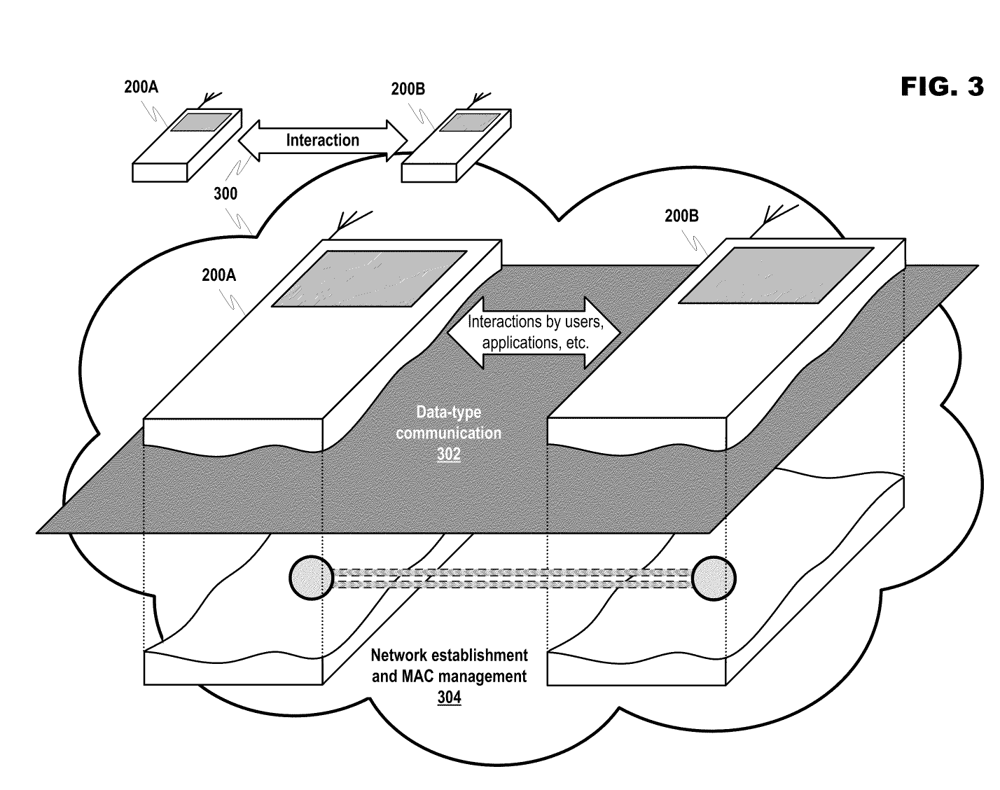

An example communication between apparatuses in accordance with at least one embodiment of the present invention is disclosed at 300 in FIG. 3. While only two apparatuses 200A and 200B are shown, the example disclosed in FIG. 3 has been presented for explanation only, and is not intended to limit the scope of the present invention. Various embodiments of the present invention may readily facilitate wireless interaction between more than two apparatuses.

Additional detail with respect to communication example 300 is disclosed further in FIG. 3. Apparatus 200A may have communication requirements that require interaction with apparatus 200B. For example, these requirements may comprise interactions by apparatus users, applications residing on the apparatuses, etc. that trigger the transmission of messages that may be generally classified under the category of data-type communication 302. Data-type communication may be carried out using messages that may be wirelessly transmitted between apparatus 200A and 200B. However, typically some form of wireless network link or connection needs to be established before any data type communication messages 302 may be exchanged.

Network establishment and media access control (MAC) management messages 304 may be utilized to establish and maintain an underlying wireless network architecture within an operating space that may be utilized to convey data type communication messages 302. In accordance with various example embodiments of the present invention, messages containing apparatus configuration, operation and status information may be exchanged to transparently establish wireless network connections when, for example, an apparatus enters an operating space. Network connections may exist between any or all apparatuses existing within the operating space, and may be in existence for the entire time that an apparatus resides in the operating space. In this way, data-type communication messages 302 may be conveyed between apparatuses using existing networks (new network connections do not need to be negotiated each time messages are sent), which may reduce response delay and increase quality of service (QoS).

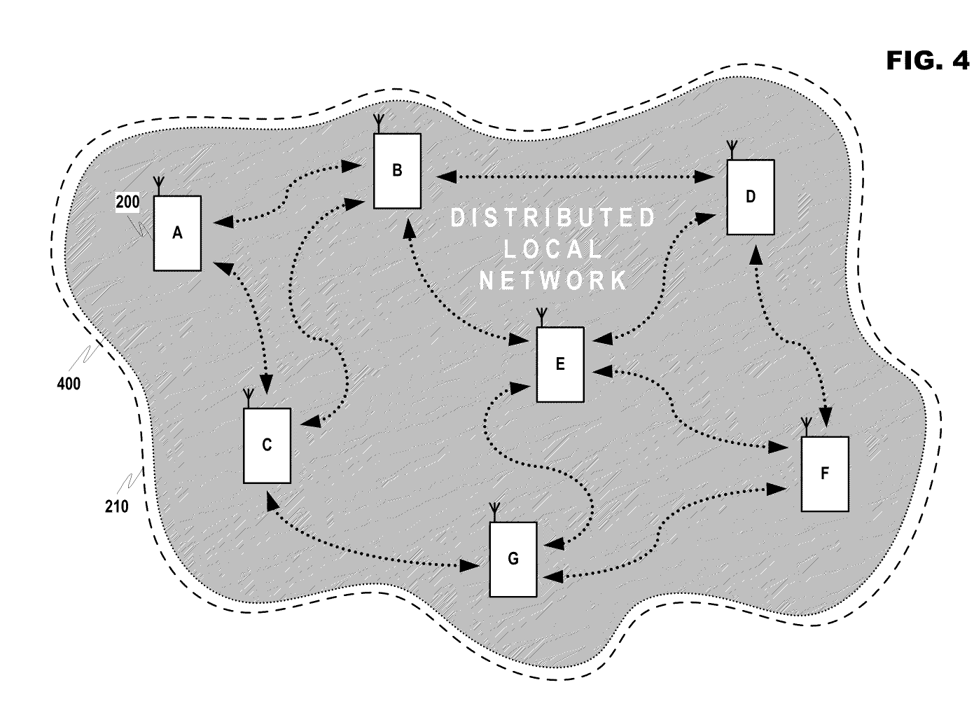

In accordance with at least one embodiment of the present invention, an example of distributed local network formation via automated network establishment and MAC management messages 304 is disclosed in FIG. 4. Apparatuses 200 entering into operational space 210 may immediately initiate network formation through the exchange operational information. Again, the exchange of this information may occur without any prompting from, or even knowledge of, a user. Example interactivity is shown in FIG. 4, wherein various network establishment and MAC management messages 304 are exchanged between apparatuses A to G. In accordance with at least one example embodiment of the present invention, messages may be exchanged directly between an originating apparatus (e.g., the apparatus that is described by information elements contained in a message) and a receiving apparatus. Alternatively, messages corresponding to apparatuses in operational space 210 may be forwarded from one apparatus to another, thereby disseminating the information for multiple apparatuses.

### IV. Example Operational Parameter: Diluted Beacon Period

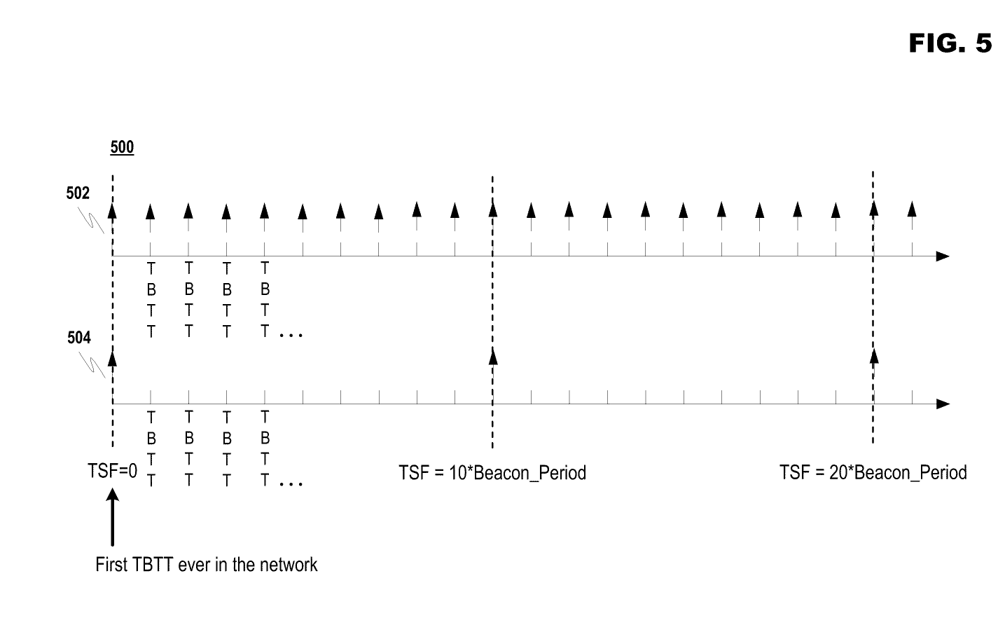

An example of information that may be communicated in network establishment and MAC management messages 304 (e.g., using information elements), in accordance with at least one example embodiment of the present invention, is disclosed in FIG. 5. The activity flow disclosed at 500 represents an example implementation based on the wireless local area networking (WLAN) standard, as defined in the IEEE 802.11 specification. However, embodiments of the present invention are not limited only to implementation with WLAN, and thus, may be applied to other wireless network architectures or communication protocols.

The WLAN logical architecture comprises stations (STA), wireless access points (AP), independent basic service sets (IBSS), basic service sets (BSS), distribution systems (DS), and extended service sets (ESS). Some of these components map directly to hardware devices, such as stations and wireless access points. For example wireless access points may function as bridges between stations and a network backbone (e.g., in order to provide network access). An independent basic service set is a wireless network comprising at least two stations. Independent basic service sets are also sometimes referred to as an ad hoc wireless network. Basic service sets are wireless networks comprising a wireless access point supporting one or multiple wireless clients. Basic service sets are also sometimes referred to as infrastructure wireless networks. All stations in a basic service set may interact through the access point. Access points may provide connectivity to wired local area networks and provides bridging functionality when one station initiates communication to another station or with a node in a distribution system (e.g., with a station coupled to another access point that is linked through a wired network backbone).

In wireless network architectures like WLAN, beacon signals may be utilized to synchronize the operation of networked apparatuses. In situations where new ad hoc networks are being created, the initiating apparatus may establish standard network beaconing based on it owns clock, and all apparatuses that join the network may conform to this standard beacon. Similarly, apparatuses that desire to join an existing wireless network may synchronize to the existing beacon. In the case of WLAN, apparatuses may synchronize to beacon signals utilizing a timing synchronization function (TSF). The timing synchronization function is a clock function that is local to an apparatus that synchronizes to and tracks the beacon period.

An example of a beacon signal is shown in FIG. 5 at 502 wherein a target beacon transmission time (TBTT) indicates the targeted beacon transmission. This time may be deemed “targeted” because the actual beacon transmission may be a somewhat delayed from the TBTT due to, for example, the channel being occupied at TBTT. The apparatuses that are active in the network may communicate with each other in accordance with the beacon period (time between two beacon transmissions). However, there may be instances where it may not be beneficial, and may possibly even be detrimental, for apparatuses to be active during each beacon period. For example, apparatuses that do not expect frequent communication within the wireless network may not benefit from being active for every beacon period. Moreover, apparatuses with limited power or processing resource may be forced to waste these precious resources by the requirement of being active for every beacon period.

In accordance with at least one embodiment of the present invention, functionality may be introduced utilizing the example distributed wireless network described above to allow apparatuses to operate at a standard beaconing rate that has been established in the network, or alternatively, using a “diluted” beaconing rate. “Diluted” beaconing may comprise a beaconing mode operating at a lower frequency than the standard beaconing rate originally established in the network. Diluted beaconing may be based on information (e.g., information elements) that is included in network beacon frames, wherein the included information may express one or more diluted beacon rates as multiples of the beacon. Using the beacon and the one or more associated diluted beacon period indications contained within beacon frames, networked apparatuses may elect to operate (e.g., via random contention) based either on the standard beacon or a diluted beacon period. In particular, all apparatuses may synchronize to the same initial target beacon transmission time (TBTT), for example when TSF=0, and may then count the number periods that occur after the initial TBTT based on the internal TSF function. In this way, apparatuses operating using a diluted beacon period may be active on TBTT counts that corresponds to the multiple defined by the diluted beaconing period.

An example diluted beacon interval of every 10^{th} TBTT is disclosed in FIG. 5 at 504. The decision on a beacon interval to utilize may be handled by each apparatus individually, (e.g., in the protocol stacks that manage operation of a radio modem). All apparatuses will then, in accordance with at least one embodiment of the present invention, operate based on a beacon interval that remains the same for the lifetime of the network. In view of the requirement that the beacon interval remain unchanged for the duration of the wireless network, the diluted beacon signal may be expressed as a multiple of the beacon signal. Starting intervals may be defined by the apparatus that formed the network, and in the example disclosed in FIG. 5 (and as previously set forth) the first TBTT is equivalent TSF=0. Other apparatuses that subsequently join the network may adopt this beacon interval parameter and TBTT timing. For example, the TBTT at TSF=0 is the “base point” that determines when beacons are transmitted. All the devices in the network may update their own TSF counters as per legacy synchronization rules, and from the TSF they may determine the particular TBTT in which to participate in beaconing assuming that, regardless of the beacon interval, the first beacon was transmitted at TSF=0.

For example, in a network comprising four apparatuses where devices 1, 2 and 4 operate using a diluted beaconing mode having a beacon interval (e.g., a time period between beacon transmissions) of every 6^{th} TBTT, all apparatuses may remain synchronized even though only device 3 may be active (e.g., “competing”) in all beaconing periods 1, 2, 3, 4 and 5 (e.g., all apparatuses may participate in TBTT 0, TBTT 6, TBTT 12, etc.) Therefore, there can be at least two different beacon periods among the apparatuses, and possibly further diluted beacon periods as other groups of apparatuses may have selected their own diluted beaconing period based on the original beaconing period and the one or more associated diluted beacon period indications transmitted therewith.

In accordance with at least one example embodiment of the present invention, beacons will contain a diluted beacon period parameter. The diluted beacon period parameter may, for example, be carried in vendor-specific information elements (IEs). Diluted beacon period parameter values may remain the same for the lifetime of the network. However, should there be need for more flexibility, other beacon intervals may be defined, and all of the defined beacon intervals may be signaled in a manner similar to the diluted beacon interval.

### V. Examples of Awake Windows

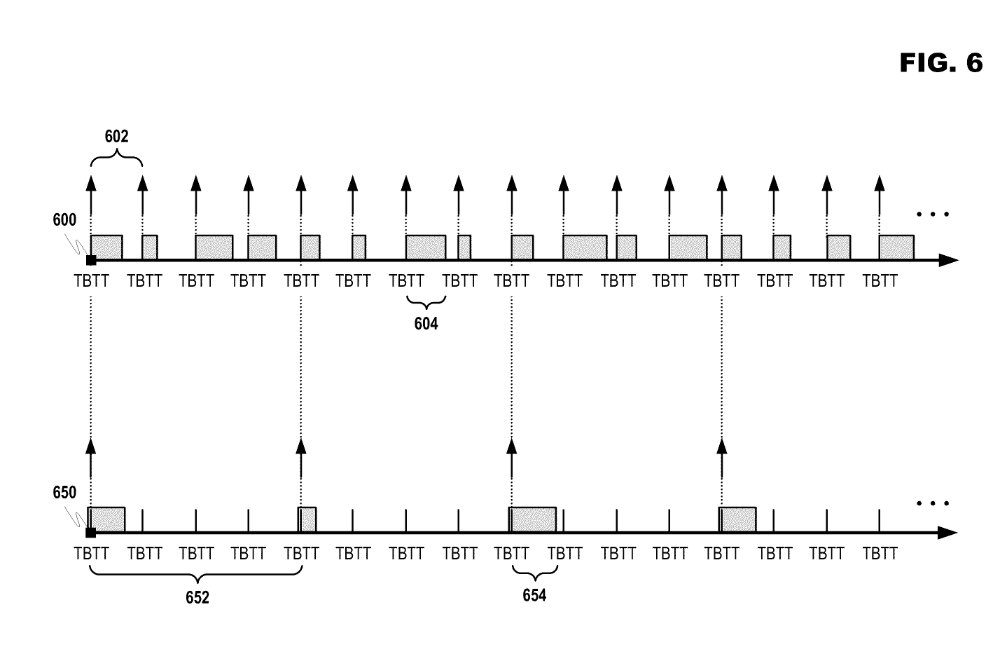

FIG. 6 discloses an example implementation of “awake windows” in accordance with at least one embodiment of the present invention. Similar to FIG. 5, a “standard” network beacon (e.g., the beacon established by the apparatus that formed the network) is shown at 600. Each target beacon transmit time (TBTT) may represent a beacon frame that is transmitted by an apparatus in the network (or at least times at which beacon transmissions were targeted, barring any delays). Thus, the interval shown at 602 may therefore define the standard beacon period.

Possible awake windows for an apparatus that is participating in the network are further shown in FIG. 6, an example of which is identified at 604. These active periods occur in accordance with each transmitted TBTT, and therefore, may be deemed aligned with the normal network beacon period. These awake windows do not necessarily represent that an apparatus has planned activity (e.g., messages queued for transmission) during these time periods. On the contrary, they are merely periods of time when apparatuses may be active, and therefore, will be able to transmit messages to, and/or receive messages from, other apparatuses in the network.

The behavior of another example apparatus in accordance with at least one embodiment of the present invention is further disclosed at 650. While all apparatuses in the network will operate based on the same origin point (e.g., TSF=0) and normal beacon period (e.g., as set forth by the TBTT), each apparatus may select an operational mode based upon the one or more diluted beacon period indications that are transmitted in the beacon. For example, the apparatus corresponding to the activity disclosed at 650 is operating utilizing diluted beacon period 652, which is a multiple “4” in this scenario. Therefore, diluted beacon period 652 may involve beacon transmissions per every four TBTTs. Awake windows, for example as shown at 654, may also occur in accordance with the diluted beacon period 652. In at least one example implementation, the awake windows may begin just prior to the commencement of the diluted beacon period.

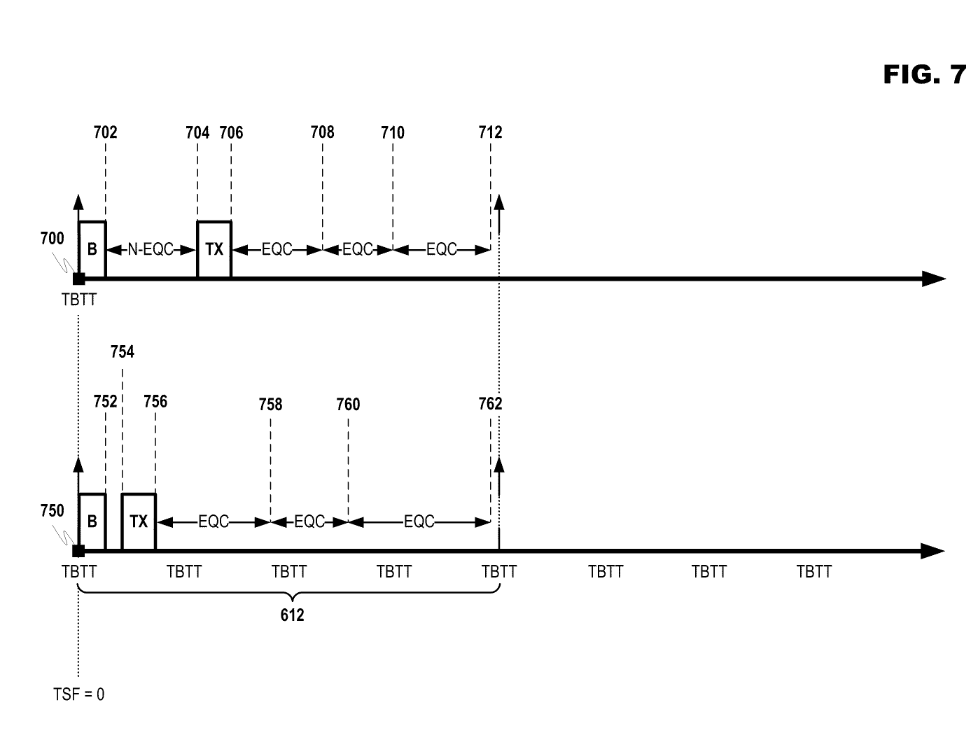

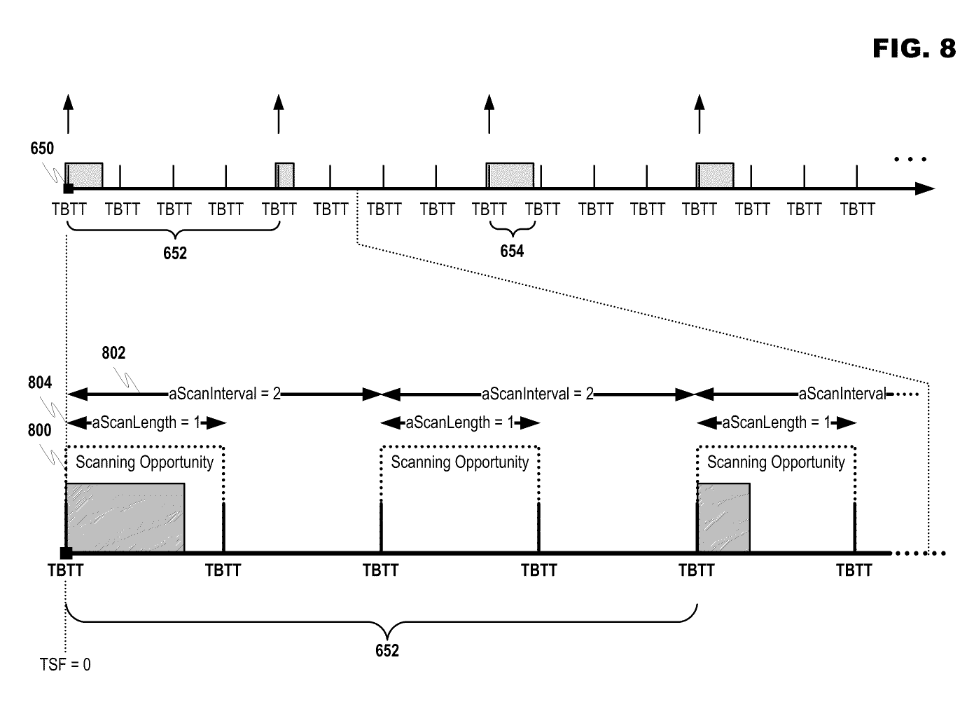

The duration of awake windows, while configured at constant duration by a predetermined information element (IE) in the beacon, may end up being variable in actual practice. For example, the awake window may be based on a MAC parameter that is similar to the beacon interval and diluted beacon period parameters. A host in the beaconing apparatus may determine it and provides it to the modem for transmission in the beacon. It may be communicated using, for example, a general or vendor specific information element (IE) as with the beacon interval and diluted beacon period. Upon awake window expiration apparatuses may attempt to transition to a “doze” or sleep state. However, the transition to doze state may, in actuality, happen earlier or later in accordance with control methodologies that will be discussed with respect to FIG. 7-8.

FIG. 7 discloses channel access control configurations that may be implemented in accordance with at least one embodiment of the present invention. Initially two channel access states may be defined: a non-empty queue contention (N-EQC) state and an empty queue contention (EQC) state. When apparatuses have no messages (frames) queued for transmission in transmit buffers, the device may be deemed in an EQC state. Alternatively, apparatuses may be deemed in an N-EQC state when there is at least one frame awaiting transmission.

The N-EQC state may comprise optional implementations: “Legacy” 700 and “Beacon Prioritized” 750. Using Legacy implementation 700, upon receiving or transmitting a beacon channel contention may be executed as in legacy devices, for example, as defined by the channel access rules specified in the particular wireless communication medium. Legacy implementation 700 represents an example of channel contention in accordance with an existing set of access control rules between 702 and 704. Once the apparatus gains access to media at 704 it will obtain a transmission opportunity (TXOP) during which it may transmit frames to the network (e.g., if one or more frames are queued for transmission. “TX” as shown between 704 and 706 in FIG. 7 represents the transmission of any queued messages. Further, frames may be received from the network as acknowledgements to the transmitted frames in the “TX” period.

In Beacon Prioritized implementation 750, the apparatus that has transmitted the network beacon is permitted to continue transmitting any frames that are queued for transmission in its transmit buffers. The apparatus obtains a TXOP for beacon transmission, and once it has transmitted the beacon at 752 it may automatically obtain a new TXOP, as shown at 754, to transmit any frames that are pending in its transmit buffers. In the disclosed example the new TXOP may start after a short interframe space (SIFS) period following the end of the beacon frame, which is represented in example 750 by the space shown between 752 and 754.

Once the apparatus has completed transmission (e.g., emptied its transmission buffers), it shall enter into an EQC state as shown in implementations 700 and 750 at 706 and 756, respectively. If an apparatus has no frames for transmission during a beacon interval, the device transition directly into an EQC state after the beacon reception/transmission (e.g., at 702, 752). When in the EQC state apparatuses may try to obtain a TXOP for a given number of times (determined, for example, by a “RepeatEmptyQueueContention” parameter). Upon obtaining a TXOP, apparatuses without pending messages may attempt to obtain a new TXOP as shown at 708/710 and 758/760 in implementations 700 and 750, respectively, instead of initiating the transmission of a frame sequence. Devices that obtain a number of TXOPs that is equal to a predetermined threshold value (e.g., RepeatEmptyQueueContention times) during a beacon interval may enter into doze or sleep state. In example implementations 700 and 750 in FIG. 7 this may occur at 712 and 762, respectively. All of these events may happen before awake window 612 expires. Moreover, example legacy implementation 700 and example beacon prioritized implementation 750 both assume that the message transmissions between 704 and 706, as well as 754 and 756, respectively, succeed, and thus, no frames are pending for (re)transmission beyond this point.

### VI. Scanning Opportunity Establishment, Usage and Related Communication

The previous discussion addressed awake periods that may occur in accordance with a diluted beacon period according to at least one embodiment of the present invention. A diluted beacon period may allow apparatuses in the network to operate less frequently, which may lessen resource usage and extend operational life. Another periodic operation that may operate alone or in conjunction with diluted beacon periods involves scanning opportunities. FIG. 8 explodes a portion of the activity flow previously shown at 650 in order to explain scanning opportunities 800. Scanning opportunities 800 represent periods of time during which apparatuses may engage in passive scanning. Scanning opportunities 800 may be initiated periodically based on an integer multiple of the network beacon signal interval (e.g., beginning from TSF=0), which may be defined in terms of the parameter aScanInterval 802 in FIG. 8. This parameter is set to “2” in the disclosed example, which means that scan opportunities will initiate on the occurrence of every other TBTT based on the network beacon signal interval. Since the diluted beacon period is set to “4” in the example embodiment of FIG. 8, a diluted beacon period will occur during every other scanning opportunity in the disclosed example.

The duration of scanning opportunity 800 may also be defined based on an integer multiple of the network beacon signal interval. In the example embodiment of FIG. 8, duration is configured by the parameter aScanLength 804 being set to “1” or one standard beacon period in the network. Any occurrence of shaded areas within scanning opportunities 800 correspond to example apparatus awake windows shown in 650 that happen to initiate at the same TBTT as scan windows 800.

An opportunity for an apparatus to be active in a network (e.g., for beaconing in accordance with the standard or diluted beacon period) may be presented during the same TBTT as scanning opportunity 800. However, in accordance with various embodiments of the present invention, apparatuses may opt not to participate in active network operations like beaconing in order to perform passive scanning. Example scanning operations, such as will be described below, may facilitate network expansion through scanning coupled with a response mechanism for conveying connectivity information to other apparatuses that may want to join the network.

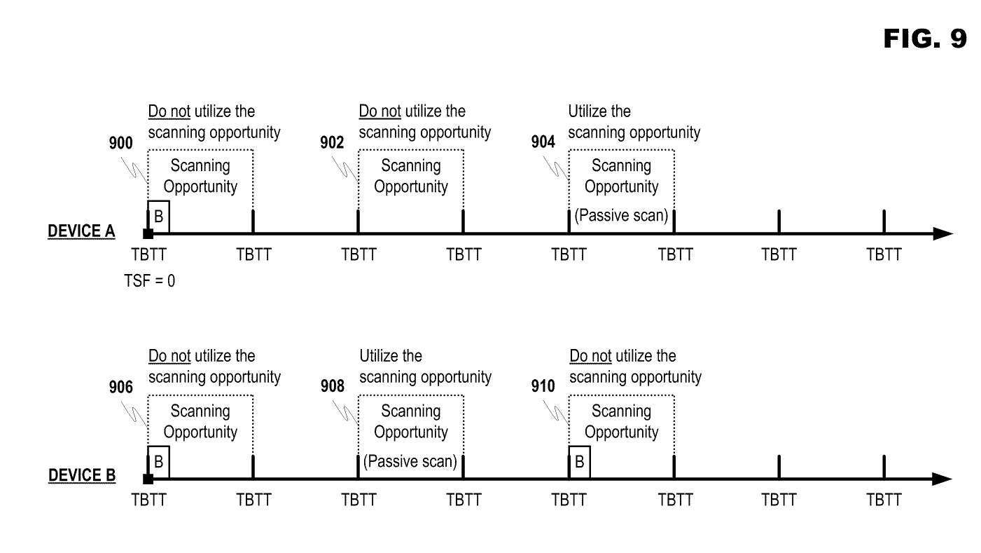

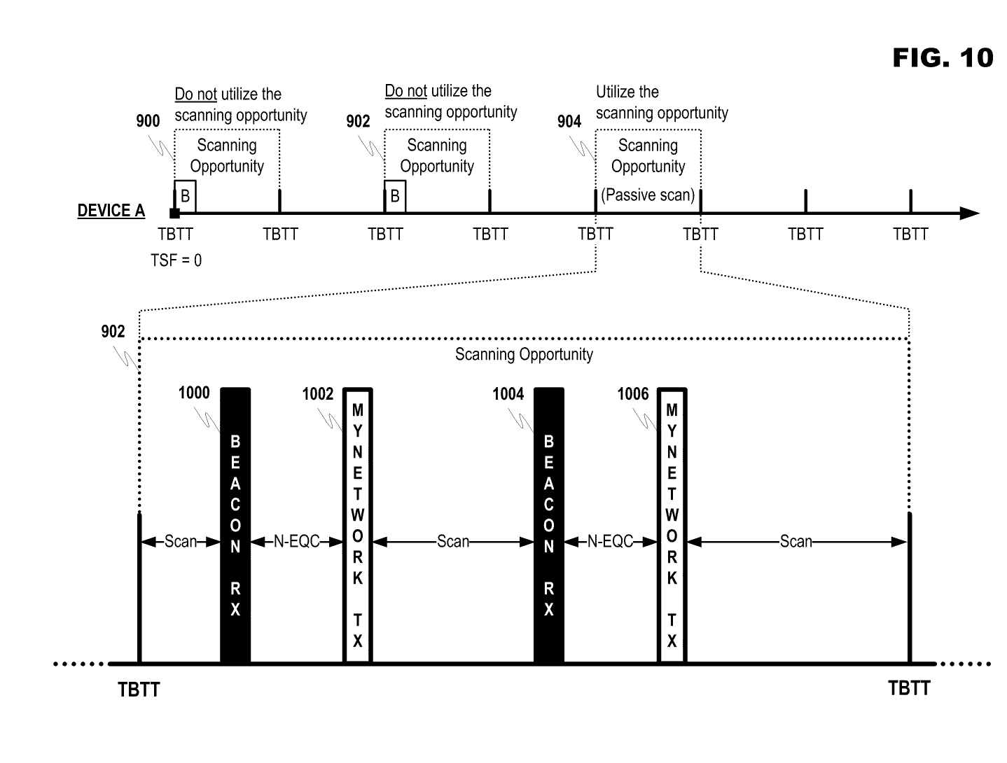

An example of scanning opportunity operation is disclosed with respect to FIG. 9. Both devices A and B are operating using a aScanInterval=2 that causes scanning opportunities to initiate every other TBTT, and each scanning opportunity has a duration (aScanLength) of one network beacon signal interval. Initially, device A elects not to utilize scanning opportunity 900. Therefore, device A may participate in standard network beaconing as defined by the communication protocol in use. However, according to at least one example embodiment, data transmission is not permitted for apparatuses engaged in a scanning opportunity, aside from beaconing, so device A may return to sleep mode after a beacon is transmitted. Device A again opts to not utilize the scanning opportunity at 902, but upon the occurrence of the next scanning opportunity 904 device A may opt to utilize the scanning opportunity. As a result, device A may perform passive scanning during scanning opportunity 904. Utilizing a scanning opportunity may, in accordance with at least one embodiment of the present invention, also incorporate other activities in addition to simple passive scanning. Examples of activities that may occur when a scanning opportunity is utilized will be described with respect to FIG. 10.

As opposed to the operation described with respect to device A in FIG. 9, device B opts not to utilize either of the scanning opportunities shown at 906 and 910. Instead, in both instances device B participates in network beaconing. During scanning opportunities 906 and 910 device B participates in network beaconing and does not transmit further information. In the second scanning opportunity 908, device B opts to utilize the scanning opportunity in the manner described above in regard to scanning opportunity 904. Apparatuses in the same network may stagger operation so that some apparatuses passively scan while others are actively beaconing.

Further to the above example, apparatuses such as device A and B disclosed in FIG. 9 would most probably not utilize every scanning opportunity for passive scanning when supporting wireless protocols like WLAN. Instead, an average of one out of aScanProbability (e.g., a parameter that defines the probability that a scanning opportunity will be utilized) of the scanning opportunities will be utilized. Therefore, the probability that apparatuses perform a scan in a single scan opportunity may be defined as 1/aScanProbability, and an apparatus may decide on the occurrence of each separate scanning opportunity whether to utilize it for scanning.

Using scanning opportunity 902 disclosed in FIG. 9 as a basis, an example of activities that may occur when a scanning opportunity is utilized is disclosed in FIG. 10. When utilizing a scanning opportunity Device A may, at some instance prior to commencing passive scanning, prepare a network information message for transmission, which is represented in the example of FIG. 10 as a “MyNetwork” message. A network information message may comprise connectivity information usable by apparatuses outside of the network for communicating with the network. For example, network information messages may comprise timing information that would allow apparatuses operating outside of the network to synchronize to network timing. Further, the network information message may also comprise information pertaining to one or more diluted beacon periods, which would allow apparatuses not only to synchronize to network timing, but also to operate in accordance with a diluted beacon period already established in the network.

For example, network information messages may comprise network information such as contained in beacon frames including network size, basic service set identifiers (BSSID), network operating frequency, etc. Apparatuses in a network to which this packet is transmitted by a scanning device may process this frame in a manner similar to the processing of in-network scanning reports. Devices may individually decide whether to react to the discovery of the new network. If an apparatus decides to react to the discovery, the apparatus will begin operating in the found network. Apparatuses may either also continue operating in the old network or move all its operations to the new network. In the case of the former, the apparatus may form a kind of gateway between the two networks. In the case of the latter, the apparatus informs the other devices in the old network about its decision to leave the network.

An example of activities that may occur during scanning opportunity 902 is also described in FIG. 10. When an apparatus that is passively scanning receives beacon signal 1000 from another network, it may initiate a transmission (Tx) and/or broadcast of a network information message, or a similar dedicated data frame, comprising connectivity information corresponding to a network in which the passively scanning apparatus is currently operating. The data frame in the disclosed example is “MyNetwork” announcement frame 1002, as the frame may be used to inform newly encountered networks about the presence of the existing network (e.g., the network to which the passively scanning apparatus belongs). The frame may be transmitted in a manner similar to data frames that would be transmitted by apparatuses operating within the network (e.g., including basic contention rules). Further, the MAC layer may be instructed that the frame needs to be made to look like a frame sent from any device operating in the other network (e.g., the network ID would need to be set to the value used in the other network). The network ID information of the other network may be taken from the beacon signal received by the scanner that triggered the scanner to transmit the MyNetwork frame.

The above process may also apply if a dedicated management frame is specified. Normal frame reception rules may apply when receiving MyNetwork frames, since by default the transaction would involve normal data type frames. Apparatuses would not be expected to handle MyNetwork frames any differently from other data type frames. Further, the frames may be delivered to the host for further processing similar to other data type frames. Alternatively, a new management frame may be specified for this purpose. Operation may continue in the manner shown at 1004 and 1006 in FIG. 10 for the duration of scanning opportunity 902.

Apparatuses utilizing scanning opportunities to passively scan for other networks may transmit MyNetwork frames (e.g., 1002 and 1006) upon receiving beacon frames from other networks (e.g., a beacon with the same service set identifier (SSID) as the network in which the apparatus is operating). When scanning is initiated, apparatuses may first prepare a MyNetwork frame ready for transmission and then enter into the non-empty queue contention state. Beacon frames received from other networks may trigger normal channel access procedures, as defined by the wireless communication protocol being used, that may then conclude with MyNetwork frame transmission. Once an apparatus has broadcasted a MyNetwork frame, it may resume passive scanning and prepare another MyNetwork frame for the next encounter (e.g., further beacons received from other networks). After a scanning opportunity expires, the apparatus may reset channel access states and flush remaining MyNetwork frames from transmission queues.

### VII. Apparatus-Network Interaction

In various embodiments of the present invention, scanning opportunities may be utilized by apparatuses within a network in order to advertise information about the network to apparatuses outside of the network. An obvious example where the benefit of such functionality would be apparent is when apparatuses enter operational spaces where previously undiscovered apparatuses and/or networks reside. However, this operation may also prove useful in situations where apparatuses were members of the larger network prior to the network losing integrity. For instance, an apparatus may be active in a large network. Links between some of the apparatuses that are participating in the large network may then become severed for a multitude of reasons (e.g., user walks out of range, public transportation such as bus or train enters a tunnel or goes below ground, etc.). Multiple networks may then result comprising members of the original large network: Initially, the network members whose link was severed from the apparatus may continue to operate in the original network. Then, network members that remain available to the apparatus (e.g., peripherals) may create a new smaller network (e.g., a local network). The new networks may operate as separate entities, but may retain the network identifier (e.g., BSSID) from the original network. As a result, it may appear to individual apparatuses within each of these networks that they are still operating in the original network, just with fewer apparatuses. Communication activities may then, such as in the examples described above, allow the two networks to recreate the original network when the apparatuses are again able to communicate.

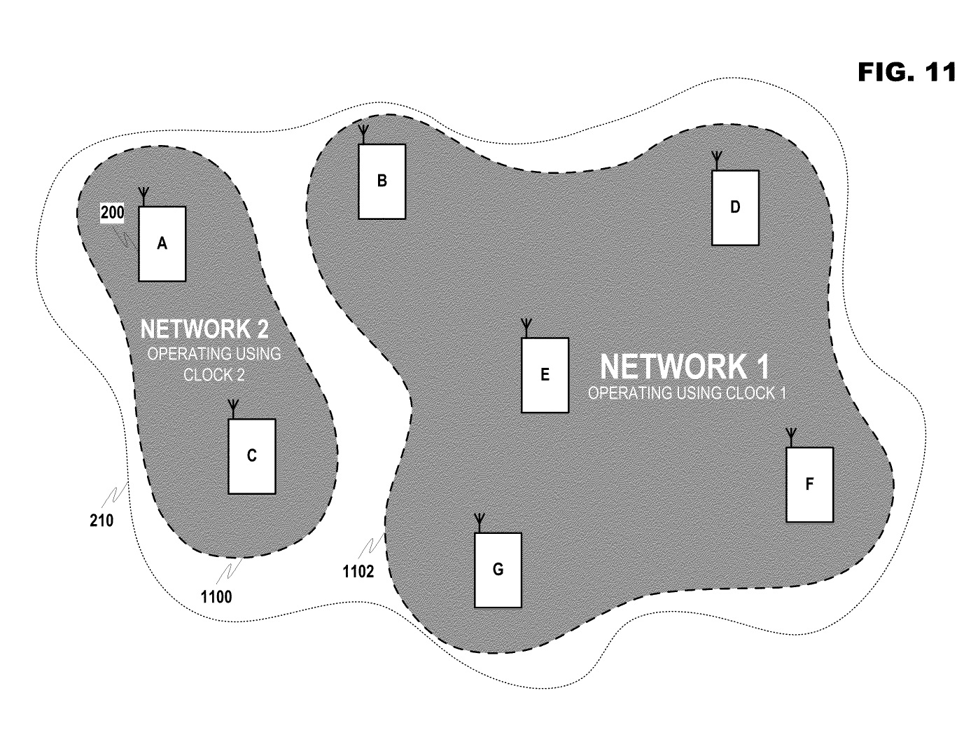

The latter situation may correspond to the more general scenario disclosed in FIG. 11. Apparatuses A to G were previously disclosed as residing in the same operational space 210. However, in FIG. 11 apparatuses A and C have become severed from apparatuses B, D, E, F and G. Apparatuses A and C have proceeded to establish “Network 2” as shown at 1100, while the other apparatuses may operate in the original “Network 1” as shown at 1102. It is important to note that the labeling (e.g., Network 1, Network 2, etc.) of the networks is merely for explanatory purposes, and that both of these networks may, in actuality, continue to utilize the same network identifier (e.g., BSSID) as original network. While apparatuses A to G may have been operating using the same timing when in operational space 210, the clocks governing networks 1 and 2 may be affected by external influences. As a result, network timing (e.g., clock 1 and clock 2) may not be synchronized, necessitating a timing adjustment in at least one of these networks.

Given the scenario presented in FIG. 11, either clock 1 or clock 2 will have to be adjusted to synchronize timing to the remaining clock, though changes such as synchronization may negatively impact network operation. For example, forcing networked apparatuses to alter their timing may cause the clocks of the devices to become unsynchronized within the network. However, even momentary lapses between apparatuses may result in missed communications as the sending and receiving apparatuses may not be active at the same time. This phenomena may be even more apparent when apparatuses are operating using diluted beacon periods since there are fewer instances for transmission and reception. In view of these potential negative impacts, it does not make sense to synchronize the timing of larger networks to smaller networks as large number of apparatuses may temporarily lose synchronization within the larger network, which may cause widespread communication delays and other quality-of-service (QoS) related issues.

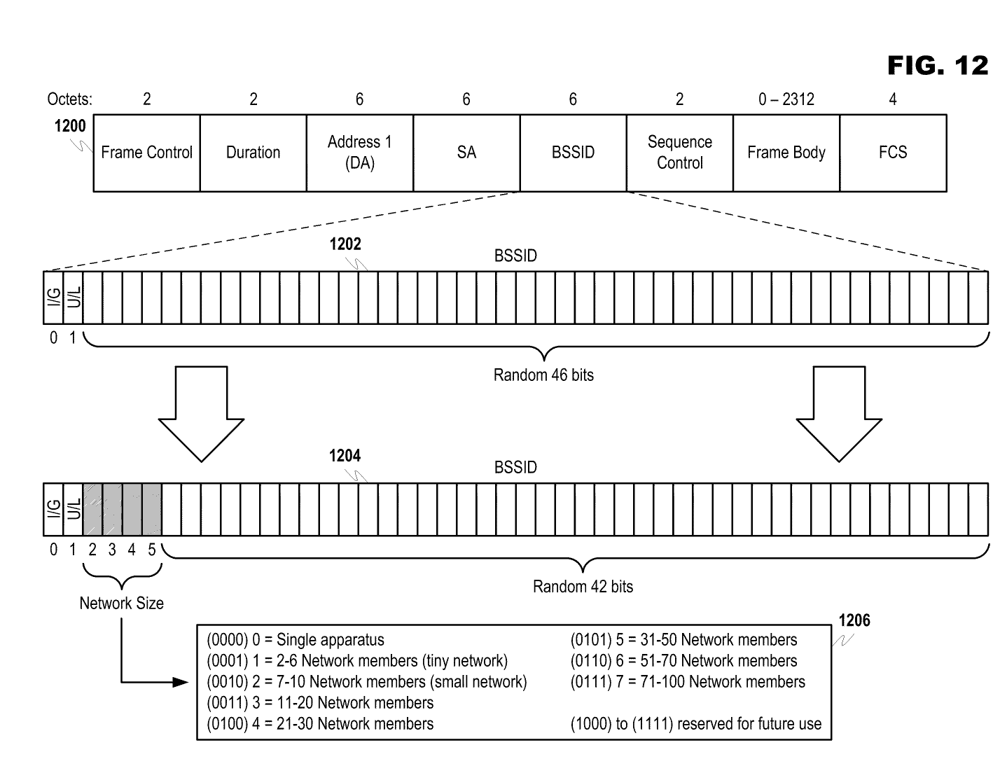

In view of the problems that may be caused by network synchronization, it may prove beneficial to utilize a more informed determination when merging separate networks. The separate networks to be merged may actually be parts of a previously existing network, and thus, may use the same network identifier (the identifier from the previously existing network). An example tool that may be utilized to support such determinations is disclosed in FIG. 12. An example network information message is disclosed at 1200. Message 1200 has a structure that is similar to beacon frames that are traditionally utilized to control communication within a network. For example, message 1200 may comprise fields such as, but is not limited to, a frame control field (2 octets), a duration field (2 octets), an address field (6 octets), a source address (SA) field (6 octets), a basic service set identifier (BSSID) field (6 octets), a sequence control field (2 octets) a frame body (0-2312 octets) and a frame check sequence (FCS) field (4 octets).

The BSSID is a 48-bit identifier corresponding to a particular Basic Service Set (BSS). In terms of the various embodiments of the present invention, the BSSID is used for the sake of example herein as network identification information provided by beacon signals that may be used to determine from which network a beacon signal was transmitted. As shown at 1202, the BSSID field is currently comprised of two defined indicator bits (“I/G” at bit 0 and “U/L” at bit 1) followed by 46 random bits. However, in accordance with at least one embodiment of the present invention it is proposed that the constitution of the BSSID field may be altered slightly in order to support network size indication without impacting the intended functionality of BSS identification. In the example proposed format shown at 1204, bits 2 through 5 have been reassigned for conveying network size while the remaining 42 random bits are utilized to identify the BSS. The four bits may be used to delineate sixteen states (e.g., “0” indicated by 0000 to “14” indicated by 1111). In accordance with at least one embodiment of the present invention, seven states are defined in chart 1206 found on the bottom of FIG. 12. Each of these seven states defines a network size in terms of a range of network members. For example, “0” (0000) may indicate a single apparatus (e.g., not in a network), while “1” (0001) may indicate a “tiny” network containing 2-6 apparatuses, and so on as set forth in chart 1206. This information may be utilized by a receiving device to determine the approximate size of the network corresponding to the network information message. Further, while FIG. 12 proposes an example methodology for communicating network size, the various embodiments of the present invention are not limited to only utilizing this methodology, and thus, may also operate utilizing an alternative methodology for conveying network size to apparatuses outside of the network.

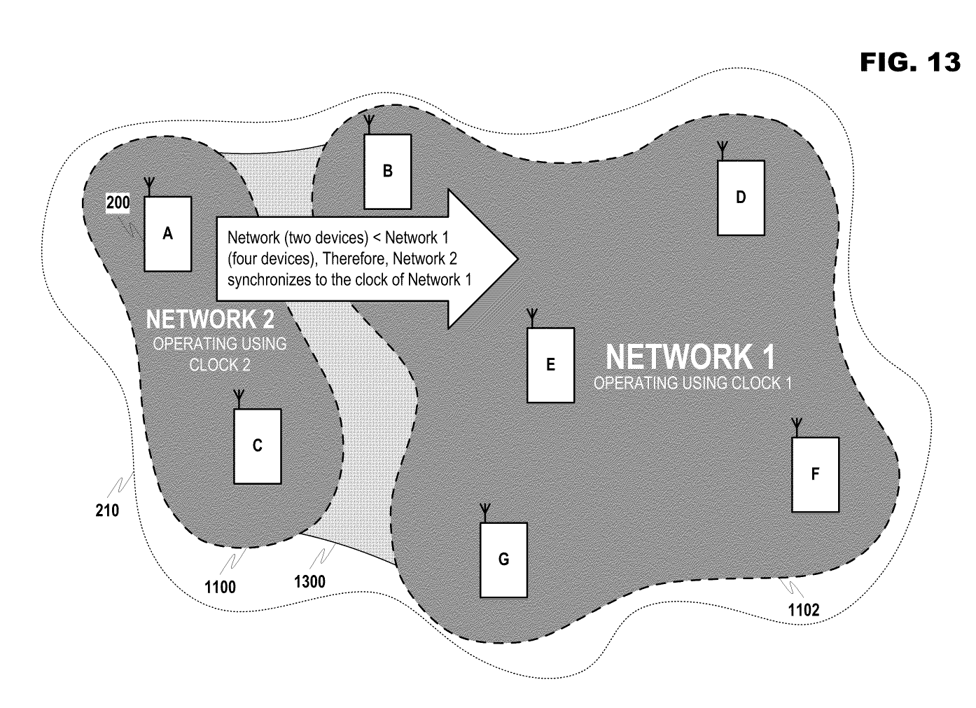

In accordance with at least one embodiment of the present invention, FIG. 13 discloses a possible consequence of considering network size during apparatus interactions. As previously described, the interaction between apparatuses A through G was severed creating two networks, network 2, shown at 1100, containing apparatuses A and C and network 1, shown at 1102, containing apparatuses B and D-G. Further, network 2 operates using a timing (clock 2) that is different than network 1, which operates using clock 1. These networks may operate using the same network identifier (BSSID) in instances where, for example, the networks were created from a previous larger network. FIG. 13 now discloses a scenario where networks 1 and 2 are again able to engage in communication (e.g., at least some of the apparatuses in both of the networks 1 and 2 are back within range of each other) and at least one apparatus in network 1 or 2 desires to interact with at least one apparatus in the other network. Initially, either network 1 or network 2 may become aware of the other network through receipt of a network information message corresponding to the other network. The network information message may further comprise network size information encoded in a predetermined format in the message. For example, the network size information may be encoded within an identification field like BSSID. Encoding network size in fixed format makes it readily accessible to receiving apparatuses, which may expedite the execution of the time-sensitive synchronization process.

Instead of just considering device-level factors that may ignore what is happening at the network level, the various embodiments of the present invention seek to minimize impacts from one apparatus participating in a new network by considering relative network size. In the example of FIG. 13, network 2, having two apparatuses as shown at 1100, may be compared to the size of network 1, which has five apparatuses as shown at 1102. Then, when the networks again mesh as shown at 1300, the timing of network 2 may synchronize to network 1. Again, synchronizing the timing of a smaller network to the timing of a larger network is preferable at least from the standpoint of potential disruption to networked devices that may occur during the synchronization process. Since network 2 has fewer apparatuses, the impact of synchronization may be considerably less than the disturbance that might be caused in the reverse case scenario.

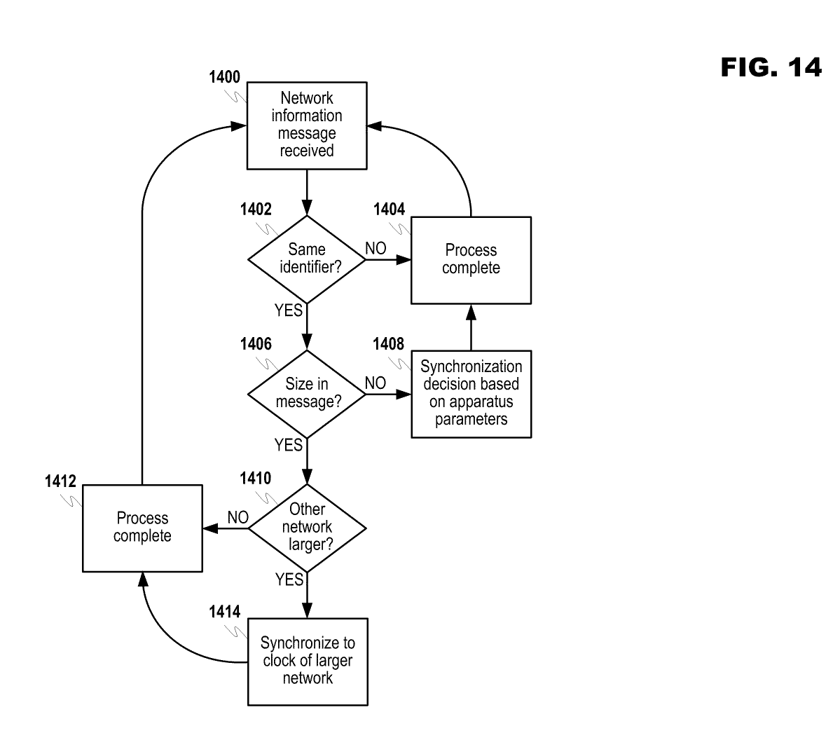

A flowchart of an example communication process in accordance with at least one embodiment of the present invention is disclosed in FIG. 14. In step 1400 a network information message may be received by an apparatus that is not participating in the network corresponding to the network information message (hereafter, “other network”). A determination may then be made in step 1402 as to whether the network information message comprises the same network identifier as at least one network in which the apparatus is currently participating. If the network identifiers are determined to be different at 1402, then in step 1404 the process may terminate.

While the process disclosed in FIG. 14 may be considered complete in step 1404, other processes pertaining to alternative modes of network formation, in accordance with at least one embodiment of the present invention, may initiate after this step. For example, the receipt of network information messages having different network identifiers may trigger a process such as disclosed in FIG. 10. This process may comprise altering the network identifier for a previously prepared network information message to be the same as the network identifier in the received network information message, and then transmitting the prepared network information message. Regardless of whether alternative processes are invoked after step 1404, the process of FIG. 14 may return to step 1400 in preparation for the receipt of further network information messages.

However, if in step 1402 the network identifier of at least one network in which the apparatus is participating is determined to be the same as the network identifier included in the received network information message, then in step 1406 a further determination may be made as to whether the network information message that was received includes size information for the other network. If the network information message omits size information, then size cannot be utilized as a criteria for making a decision about how to manage inter-network synchronization. As a result, decisions regarding how to adjust timing may be made in step 1408 based on apparatus factors instead of network factors. For example, an apparatus entering a network may simply adopt the timing of the new network. Otherwise, an apparatus with operational limitations such as power and/or processing constraints may request that the network adopt its current timing in order to conserve resources. The process may then terminate in step 1404 and return to step 1400 in preparation for the next network information message.

If the network information message does comprise size information, then in step 1410 a further determination may be made as to whether the size of the other network is larger than the size of any network that currently includes the apparatus. A determination that the apparatus' existing network is larger than the other network may result in no action, wherein the apparatus does not synchronize to the other network. As a result, the process may be complete in step 1412 and may return to step 1400 in preparation for further network information messages. Alternatively, if the other network is deemed to be bigger that the current network of the apparatus, then in step 1410 the apparatus may synchronize its timing to the timing of the other network. For example, if the apparatus is not currently operating in a network, the other network would be considered larger (e.g., since it takes at least two apparatuses to form a network). The process may then terminate in step 1412 and return to step 1400 in preparation for further network information messages.

Further to the above, the various example embodiments of the present invention are not strictly limited to the above implementations, and thus, other configurations are possible.

For example, apparatuses in accordance with at least one embodiment of the present invention may comprise means for receiving a wireless message in an apparatus, means for determining if the received wireless message comprises a network identifier corresponding to a network in which the apparatus is participating, means for, if the received wireless message comprises a network identifier corresponding to a network in which the apparatus is participating, determining whether the received wireless message also comprises network size information, means for, if the received wireless message comprises network size information, comparing the network size indicated in the received wireless message to the network size the apparatus indicates in its own transmissions, and means for, if the network size indicated in the received wireless message is determined to be larger than the network size the apparatus indicates in its own transmissions, synchronizing timing in the apparatus to timing of the received wireless message.

At least one other example embodiment of the present invention may include electronic signals that cause apparatuses to receive a wireless message in an apparatus, determine if the received wireless message comprises a network identifier corresponding to a network in which the apparatus is participating, if the received wireless message comprises a network identifier corresponding to a network in which the apparatus is participating, determine whether the received wireless message also comprises network size information, if the received wireless message comprises network size information, compare the network size indicated in the received wireless message to the network size the apparatus indicates in its own transmissions, and if the network size indicated in the received wireless message is determined to be larger than the network size the apparatus indicates in its own transmissions, synchronize timing in the apparatus to timing of the received wireless message.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
receiving a wireless message in an apparatus;
determining if the received wireless message comprises a network identifier corresponding to a network in which the apparatus is participating;
if the received wireless message comprises a network identifier corresponding to a network in which the apparatus is participating, determining whether the received wireless message also comprises network size information;
if the received wireless message comprises network size information, comparing the network size indicated in the received wireless message to the network size the apparatus indicates in its own transmissions; and
if the network size indicated in the received wireless message is determined to be larger than the network size the apparatus indicates in its own transmissions, synchronizing timing in the apparatus to timing of the received wireless message.

2. The method of claim 1, wherein the network size information is encoded in a field containing identification information within the received wireless message.

3. The method of claim 2, wherein the field contains a basic service set identifier (BSSID) in which the network size information is encoded within four bits that are configured to define multiple ranges that approximate the number of apparatuses in the network.

4. The method of claim 1, wherein if the received wireless message does not include network size information the apparatus determines whether to synchronize to the timing to the received wireless message based at least on apparatus-related parameters.

5. The method of claim 1, wherein if the network size indicated in the received wireless message is determined to be smaller than the network size the apparatus indicates in its own transmissions, the apparatus does not synchronize to the timing of the received wireless message.

6. The method of claim 1, wherein if the received wireless message comprises a network identifier corresponding to another network, initiating transmission of a network information message including a network identifier taken from the received wireless message.

7. The method of claim 1, wherein the received wireless message comprises at least network beacon period information corresponding to the network.

8. A computer program product comprising computer executable program code recorded on a computer readable storage medium, the computer executable program code comprising:
code configured to cause the reception of a wireless message in an apparatus;
code configured to determine if the received wireless message comprises a network identifier corresponding to a network in which the apparatus is participating;
code configured to, if the received wireless message comprises a network identifier corresponding to a network in which the apparatus is participating, determine whether the received wireless message also comprises network size information;
code configured to, if the received wireless message comprises network size information, compare the network size indicated in the received wireless message to the network size the apparatus indicates in its own transmissions; and
code configured to, if the network size indicated in the received wireless message is determined to be larger than the network size the apparatus indicates in its own transmissions, cause synchronization of timing in the apparatus to timing of the received wireless message.

9. The computer program product of claim 8, wherein the network size information is encoded in a field containing identification information within the received wireless message.

10. The computer program product of claim 9, wherein the field contains a basic service set identifier (BSSID) in which the network size information is encoded within four bits that are configured to define multiple ranges that approximate the number of apparatuses in the network.

11. The computer program product of claim 8, further comprising code configured to, if the received wireless message does not include network size information the apparatus, determine whether to synchronize to the timing to the received wireless message based at least on apparatus-related parameters.

12. The computer program product of claim 8, further comprising code configured to, if the network size indicated in the received wireless message is determined to be smaller than the network size the apparatus indicates in its own transmissions, cause the apparatus to not synchronize to the timing of the received wireless message.

13. The computer program product of claim 8, further comprising code configured to, if the received wireless message comprises a network identifier corresponding to another network, cause initiation of transmission of a network information message including a network identifier taken from the received wireless message.

14. The computer program product of claim 8, wherein the received wireless message comprises at least network beacon period information corresponding to the network.

15. An apparatus, comprising:
at least one processor; and
at least one memory including executable instructions, the at least one memory and the executable instructions being configured to, in cooperation with the at least one processor, cause the device to perform at least the following:
receive a wireless message in the apparatus;
determine if the received wireless message comprises a network identifier corresponding to a network in which the apparatus is participating;
if the received wireless message comprises a network identifier corresponding to a network in which the apparatus is participating, determine whether the received wireless message also comprises network size information;
if the received wireless message comprises network size information, compare the network size indicated in the received wireless message to the network size the apparatus indicates in its own transmissions; and
if the network size indicated in the received wireless message is determined to be larger than the network size the apparatus indicates in its own transmissions, synchronize timing in the apparatus to timing of the received wireless message.

16. The apparatus of claim 15, wherein the network size information is encoded in a field containing identification information within the received wireless message.

17. The apparatus of claim 16, wherein the field contains a basic service set identifier (BSSID) in which the network size information is encoded within four bits that are configured to define multiple ranges that approximate the number of apparatuses in the network.

18. The apparatus of claim 15, wherein if the received wireless message does not include network size information the apparatus determines whether to synchronize to the timing to the received message based at least on apparatus-related parameters.

19. The apparatus of claim 15, wherein if the network size indicated in the received wireless message is determined to be smaller than the network size the apparatus indicates in its own transmissions, the apparatus does not synchronize to the timing of the received wireless message.

20. The apparatus of claim 15, wherein if the received wireless message comprises a network identifier corresponding to another network, initiating transmission of a network information message including a network identifier taken from the received wireless message.

21. The apparatus of claim 15, wherein the received wireless message comprises at least network beacon period information corresponding to the network.

22. A system, comprising:
an apparatus participating in a first network; and
a second network;
the apparatus receiving a wireless message from the second network and determining if the received wireless message comprises a network identifier corresponding to the first network;
the apparatus further, if the received wireless message comprises a network identifier corresponding to the first network, determining whether the received wireless message also comprises network size information;
the apparatus further, if the received wireless message comprises network size information, comparing the network size indicated in the received wireless message to the network size the apparatus indicates in its own transmissions and if the network size indicated in the received wireless message is determined to be larger than the network size the apparatus indicates in its own transmissions, synchronizing timing in the apparatus to timing of the received wireless message.
